(19) United States
(12) Patent Application Publication
(10) Pub. No.: US 2025/0251914 A1
(43) Pub. Date: Aug. 7, 2025

(54) METHOD AND SYSTEM FOR GENERATING RECOMMENDATIONS USING GENERATIVE ARTIFICIAL INTELLIGENCE (AI) MODEL

(71) Applicant: HCL Technologies Limited, New Delhi (IN)

(72) Inventors: Rohit Ahlawat, Redmond, WA (US); Rajesh Krishnan Chirankumarath, Redmond, WA (US); Sachidanand Sharma, Redmond, WA (US); RAJU NVN, Vancouver (CA)

(21) Appl. No.: 18/640,028

(22) Filed: Apr. 19, 2024

(30) Foreign Application Priority Data
Feb. 7, 2024 (IN) 202411008223

(51) Int. Cl. G06F 8/33; G06F 8/34

(52) U.S. Cl. CPC G06F 8/33; G06F 8/34

(57) ABSTRACT

The disclosure relates to a method and system of visually inspecting computational geometry code. The method may include receiving, from a user, a query associated with a subject data, and selecting, in real time, one or more relevant vectors associated with subject data from a plurality of vectors associated with the subject data, based on the query. The method may further include inputting vectors associated with the query along with the one or more relevant vectors associated with subject data based on the query, to a Generative Artificial Intelligence (GenAI) model, and receiving, from the GenAI model, recommendations corresponding to the vectors associated with the query and the one or more relevant vectors associated with subject data based on the query inputted to the GenAI model.

### TECHNICAL FIELD

This disclosure relates generally to a product release process, and in particular to a method and a system for generating recommendations using Generative Artificial Intelligence (GenAI) model, for the product release process.

### BACKGROUND

Product development lifecycle is an iterative process and mired with challenges. The challenges keep escalating as products get more complex features. For example, one of the challenges is the fragmented approach that is followed in the product development lifecycle, such that the requirements pertaining to the underlying systems and infrastructure are dealt with in silos. Further, availability, usability, support, and training requirements are handled separately by operations division. This reduces continuous collaboration to an orchestrated intervention-driven approach. Another challenge is associated with requirement analysis. An output document includes all the information about the product that the company is creating for the customer, and an output document can lead to misunderstandings and incorrect implementations and wasted time, effort, and costs, that are hard to recover later. Further, as product lines become complicated, companies may face complexity in bridging the gap between developers and the operations team. Furthermore, it is difficult for developers to predict exactly how long a software application life is likely to be, especially during the new software development phase. Moreover, if the process is not planned properly, the project can take more time and incur a higher cost. Sometimes, correcting bugs in the code can take long periods of time.

Therefore, there is a need for solutions that can analyze complexity, change, or customer impact associated with the product development in real-time, and generate recommendations based on external and internal data.

### SUMMARY

In an embodiment, a method of generating recommendations using Generative Artificial Intelligence (GenAI) is disclosed. For example, the recommendations may relate to software product release. The method may include receiving, from a user, a query associated with a subject data, and selecting, in real time, one or more relevant vectors associated with subject data from a plurality of vectors associated with the subject data, based on the query. The plurality of vectors may be associated with the subject data are stored in a database. The method may further include inputting vectors associated with the query along with the one or more relevant vectors associated with subject data based on the query, to a Generative Artificial Intelligence (GenAI) model, and receiving, from the GenAI model, recommendations corresponding to the vectors associated with the query and the one or more relevant vectors associated with subject data based on the query inputted to the GenAI model.

In another embodiment, a system for generating recommendations using Generative Artificial Intelligence (GenAI) is disclosed. The system includes a processor and a memory. The memory stores a plurality of processor-executable instructions, which upon execution, cause the processor to receive, from a user, a query associated with a subject data, and select, in real time, one or more relevant vectors associated with subject data from a plurality of vectors associated with the subject data, based on the query. The plurality of vectors may be associated with the subject data are stored in a database. The processor-executable instructions, upon execution, further cause the processor to input vectors associated with the query along with the one or more relevant vectors associated with subject data based on the query, to a Generative Artificial Intelligence (GenAI) model, and receive, from the GenAI model, recommendations corresponding to the vectors associated with the query and the one or more relevant vectors associated with subject data based on the query inputted to the GenAI model.

In yet another embodiment, a non-transitory computer-readable medium storing computer-executable instructions for generating recommendations is disclosed. The computer-executable instructions are configured for receiving, from a user, a query associated with a subject data, and selecting, in real time, one or more relevant vectors associated with subject data from a plurality of vectors associated with the subject data, based on the query. The plurality of vectors may be associated with the subject data are stored in a database. The computer-executable instructions are further configured for inputting vectors associated with the query along with the one or more relevant vectors associated with subject data based on the query, to a Generative Artificial Intelligence (GenAI) model, and receiving, from the GenAI model, recommendations corresponding to the vectors associated with the query and the one or more relevant vectors associated with subject data based on the query inputted to the GenAI model.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating recommendations, in accordance with some embodiments of the present disclosure.

FIG. 2 is a functional block diagram of the recommendations generating device showing one or more modules, in accordance with some embodiments.

FIG. 3 illustrates an overall process of an implementation of the system of FIG. 1 for product planning and design, in accordance with some embodiments.

FIG. 4 illustrates an overall architecture of a self-service bot implementation of the recommendation generating device, in accordance with some embodiments.

FIG. 5 illustrates an overall architecture of a chatbot implementation of the recommendation generating device, in accordance with some embodiments.

FIG. 6 illustrates an overall architecture of another chatbot implementation of the recommendation generating device, in accordance with some embodiments.

FIG. 7 illustrates a flowchart of a method of generating recommendations, in accordance with some embodiments.

FIG. 8 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject relates to a method and system for generating recommendations using Generative Artificial Intelligence (GenAI) model. The techniques of the present subject matter enable GenAI-based decision making into product lifecycle so that each complexity, change, or customer impact associated with the product can be analyzed in real-time and product decisions are made based on certain parameters (external and internal key performance indicators (KPIs)). GenAI (for example, ChatGPT) may use Large Language Models (LLM) for generating predictions. In an implementation of the present subject matter, trained LLMs and trained datasets are used to simplify the process of product release using actionable inputs. Key release metrics are predicted to iterate the release process to align with variations.

Each product release can be planned around specific internal and external KPIs that may carry specific real-time weights into the decision making based on GenAI modeling. For example, the external KPIs may include a customer voice, a sentiment analysis, a customer analysis, a geo adoption, a historical support ticket data, an ecosystem play, and a competition analysis. Internal KPIs may include a faster deployment setup, a deployment execution, a leveraging of conversational AI to search and retrieve knowledge from repositories, a release success rate, a number of defects escaped, a defect density, a number of releases, a release duration, a number of releases backouts, a downtime due to release, an on-time delivery, a mean time to resolve (MTTR), and an average cost per release.

As will be appreciated by those skilled in the art, GenAI may provide various advantages including improving overall efficiency of build and release process, allowing testers to do the work of multiple people with AI-powered tests, efficiently triaging and prioritizing critical issues, thereby leading to faster response ties and improved software quality, and accurately detecting and analyzing defects in textual descriptions for identifying and categorizing bugs.

Generally, the process of generating recommendations regarding a product's lifecycle is based on tribal knowledge of key decision makers with engineering capacity and customer insights. However, the conventional techniques of generating recommendations suffer from various challenges, for example, disjointed external customer inputs and internal product release planning, complex process due to cross functional teams, frequent changes in the requirements (that affects the test automation frameworks and test scripts), and lack of infrastructure for security and data privacy compliance.

To this end, the techniques of the present subject matter provide for an ability to scan customized large dataset using GenAI and build insights for each step of decision making. Further, a knowledge of an impact on different functions helps deliver improved results. The techniques further provide for fine tuning the KPIs with different data sources, for example, customer adoption, competition, market sentiments, bugs, team capacity, etc. The techniques further provide for real-time planning of release taking into account feature backlog. The techniques further provide for optimizing product and price, and implement policies-based pricing and promotions, and payload management. Further, the techniques take into account product support, competition actions, and market demands to tweak the product planning, as required. As release management depends on different level of services, the techniques provide for modeling various features associated with the product release, such as release communication plan and release pipelines. The techniques use real-time external customer inputs and combine these with internal KPIs (engineering capacity) to generate GenAI-based recommendations for release planning, thereby resulting in better return on investment (ROI). The techniques further reduce average handling time. Furthermore, the techniques improve quality and accuracy of predictions, by creating reusable knowledge content. Moreover, the techniques provide for self-service containment rates using the GenAI powered chatbot, and improve the end-user experience, thereby increasing productivity.

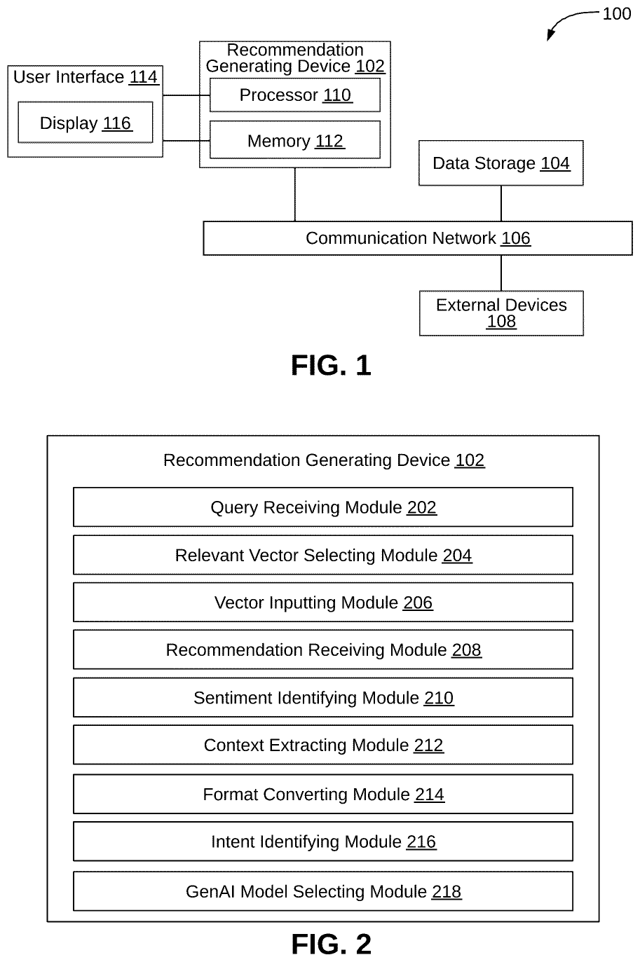

Referring now to FIG. 1, a block diagram of an exemplary system 100 for generating recommendations is illustrated, in accordance with some embodiments of the present disclosure. The system 100 may implement a recommendation generating device 102. The system 100 may further include a data storage 104 (also referred to as database 104). In some embodiments, the data storage 104 may store a plurality of vectors associated with a subject data. The recommendation generating device 102 may be a computing device having data processing capability. In particular, the recommendation generating device 102 may have the capability for generating recommendations using generative artificial intelligence (AI) model. Examples of the recommendation generating device 102 may include, but are not limited to a desktop, a laptop, a notebook, a netbook, a tablet, a smartphone, a mobile phone, an application server, a web server, or the like.

Additionally, the recommendation generating device 102 may be communicatively coupled to an external device 108 for sending and receiving various data. Examples of the external device 108 may include, but are not limited to, a remote server, digital devices, and a computer system. The recommendation generating device 102 may connect to the external device 108 over a communication network 106. The recommendation generating device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108.

The recommendation generating device 102 may be configured to perform one or more functionalities that may include receiving, from a user, a query associated with a subject data, and selecting, in real time, one or more relevant vectors associated with subject data from a plurality of vectors associated with the subject data, based on the query. The plurality of vectors associated with the subject data are stored in the database 104. The one or more functionalities may further include inputting vectors associated with the query along with the one or more relevant vectors associated with subject data based on the query, to a GenAI model. The one or more functionalities may further include receiving, from the GenAI model, recommendations corresponding to the vectors associated with the query and the one or more relevant vectors associated with subject data based on the query inputted to the GenAI model.

To perform the above functionalities, the recommendation generating device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the recommendation generating device 102.

Referring now to FIG. 2, a block diagram of the recommendation generating device 102 showing one or more modules is illustrated, in accordance with some embodiments. In some embodiments, the recommendation generating device 102 may include a query receiving module 202, a relevant vector selecting module 204, a vector inputting module 206, a recommendation receiving module 208, a sentiment identifying module 210, a context extracting module 212, a format converting module 214, an intent identifying module 216, and a GenAI model selecting module 218.

The query receiving module 202 may be configured to receive a query associated with a subject data, from a user. For example, the user may provide the query using the user interface 114. In some embodiments, the subject data may include internal data and external data associated with the query. By way of an example, the internal data may include: engineering data, connectors data, and plugins data associated with the subject data. The external data, for example, may include: customer feedback data, competitor analysis data, and pricing data associated with the subject data. Further, in some embodiments, the subject data may include historical data corresponding to failure incidents and troubleshooting incidents.

The query may be in text format or voice format. Further, the subject data may be associated with one of: a text format, image format, and an audio format. It should be noted that a plurality of vectors associated with the subject data may be stored in the database 104. As such, the audio format of the subject may be first converted into text format. To this end, the format converting module 214 may be configured to convert the audio format associated with the subject data into text format. Accordingly, the plurality of vectors associated with the subject data may be generated based on the text format associated with the subject data. in some embodiments, the text format may be a JSON format.

The relevant vector selecting module 204 may be configured to selecting in real time, one or more relevant vectors associated with subject data from a plurality of vectors associated with the subject data, based on the query.

The vector inputting module 206 may be configured to input vectors associated with the query along with the one or more relevant vectors associated with subject data based on the query, to a Generative Artificial Intelligence (GenAI) model. In some embodiments, a plurality of GenAI models may be available. To this end, the GenAI model selecting module 218 may be configured to select the GenAI model from a plurality of GenAI models, based on the query and the one or more relevant vectors associated with subject data based on the query.

The recommendation receiving module 208 may be configured to receive, from the GenAI model, recommendations corresponding to the vectors associated with the query and the one or more relevant vectors associated with subject data based on the query inputted to the GenAI model.

The sentiment identifying module 210 may be configured to identify sentiment associated with the subject data associated with the subject data, using a sentiment analysis model. The sentiment identifying module 210 may be further configured to generate a plurality of sentiment vectors based on the sentiment.

The context extracting module 212 may be configured to extract context associated with the subject data associated with the subject data, using a context analysis model. The context extracting module 212 may be further configured to generate the plurality of context vectors based on the context.

The intent identifying module 216 may be configured to identify an intent associated with the query associated with the subject data. The intent identifying module 216 may be further configured to generate the plurality of vectors associated with the subject data, based on the query and the intent associated with the query.

The above-mentioned modules may perform may be implemented in various application areas associated with the software product release, as is discussed in detail in the below sections.

### Product Planning and Designing

During the product planning and designing phase of product release process, the recommendation generating device 102 may scan customized large dataset using a GenAI to build insights. This helps to deliver improved results (as compared to the conventional process of running customer or partner insight sessions and building feature pipeline). Further, the sentiment identifying module 210 may perform sentiment analysis on product features for identifying and extracting opinions about specific features of the product, for example, from text data. The text data may be based on customer reviews, social media posts, and surveys. This data may be used to improve product development, marketing, and customer service. Further, the text data may include team's internal libraries and customer ticket data that may be used to build models and recommendations of feature backlogs for releases.

By way of an example, following types of input data may be used by the recommendation generating device 102: customer voice data, competitive analysis data (including real-time inputs of competition features and analyst ratings), product pricing and adoption data across feature sets, data associated with product features, connectors, dependencies, and telemetry, and sentiment analysis data. The input data may further include engineering capacity data, customer support data, compliance data, and marketing and events. The input data may further include other internal data including release notes data, historical data, engineering capacity data, test cases data, release efforts data, and upcoming features data.

With respect to product planning and designing, the recommendation generating device 102 may, therefore, provide various advantages including providing timely and accurate information, locating information from video content, thereby providing time efficiency, higher digital adoption, and lesser cognitive load on employees. In some embodiments, the GenAI model may be an Azure Open AI-based model.

For example, the relevant vector selecting module 204 may map contents of voice recordings (for example, “Microsoft Teams” recordings, video reviews, web queries, customer feedback, customer support ticketing data, market news and sentiment and customer adoption, success stories, and historical feature sets of products) and text documents as vectors and identify most relevant vector (content) based on the query asked by a user (for example, a support executive). For example, using “Azure Cognitive Service”, the format converting module 214 may convert the audio format associated with the subject data associated with the query into text format (e.g. JSON format). Based on the text format associated with the subject data, the format converting module 214 may generate the plurality of vectors associated with the subject data. The plurality of vectors may be stored in the database 104. Further, a custom Machine Learning (ML) model may be used to generate embeddings and provide location of the content within the document and audio or video file. For example, a large language model (LLM) may be used to provide the formatted response to the user's query to combine the parts of the relevant content and create a holistic response.

The sentiment identifying module 210 may identify and extract sentiments (i.e. opinions) about specific features of a product from the text data, such as customer reviews, social media posts, and surveys. The opinions may be used to improve product development, marketing, and customer service.

To this end, the input data may include audio data from customers. For example, a subset of potential users may be given an early access to a new or updated version of the product and asked to provide feedback on its functionality, usability, and value proposition. The GenAI model may be used to analyze the feedback data and generate insights on customer satisfaction, preferences, pain points, and suggestions for improvement.

Further, the GenAI model may be used to automate and enhance the competition analysis process. Using the GenAI mode, various sources of information, such as product websites, reviews, social media, news articles, analyst reports, and customer feedback may scanned to extract relevant data on competitor products. In some embodiments, the GenAI model may also use natural language processing (NLP) and machine learning (ML) to generate summaries, comparisons, and ratings of competitor products based on different criteria and dimensions. The GenAI model may be used to identify emerging trends, opportunities, and threats in the competitive landscape and provide recommendations for product strategy and positioning.

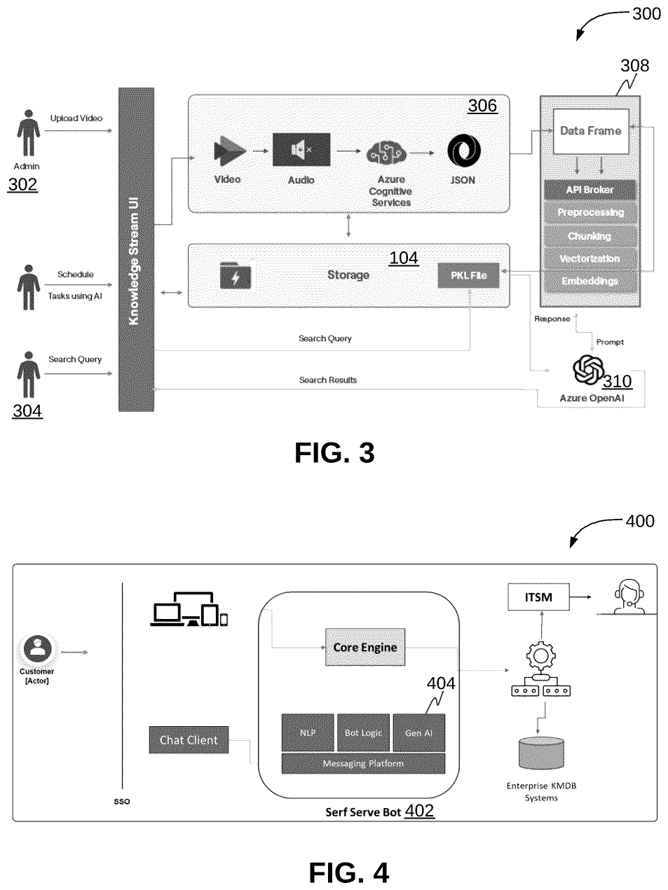

The GenAI model may be further used to optimize the product pricing and adoption across different feature sets. In particular, the GenAI model may be used to analyze the customer behavior, preferences, and willingness to pay for various features and functionalities of the product. Further, the GenAI model may be used for benchmarking the product pricing against the competitors and the market demand. Furthermore, the GenAI model may be used for generating dynamic pricing models and scenarios that can maximize the revenue and profitability of the product. Further, the GenAI model may be used to generate insights into the feature adoption and usage patterns of the customers and suggest ways to increase the customer retention and satisfaction. The GenAI model may generate recommendations related to dynamic decisions on release subsets, and competition and security threats. An overall process of the implementation of the system 100 for product planning and designing is illustrated in FIG. 3.

Referring now to FIG. 3, an overall process 300 of product planning and designing is illustrated, in accordance with some embodiments. As shown in FIG. 3, subject data may be received from one or more admin users 302. Further, a query associated with a subject data may be received from a user 304. The subject data may be in a text format, audio format, or video format. The audio and the video format associated with the subject data may be converted into text format, at 306, for example by the format converting module 214. Further, a plurality of vectors associated with the subject data may be generated based on the text format associated with the subject data. For example, the text format may be a JSON format. In some embodiments, the format converting module 214 may use “Azure Cognitive Services” for converting the audio and the video format associated with the subject data into text format. The subject data in the text format may be stored in the database (storage) 104.

At 308, the relevant vector selecting module 204 may select, in real time, one or more relevant vectors associated with subject data from a plurality of vectors associated with the subject data, based on the query. The vector inputting module 206 may input vectors associated with the query along with the one or more relevant vectors associated with subject data based on the query, to a Generative Artificial Intelligence (GenAI) model 310. The recommendation receiving module 208 may receive, from the GenAI model 310, recommendations corresponding to the vectors associated with the query and the one or more relevant vectors associated with subject data based on the query inputted to the GenAI model 310.

### Customer Support

### ‘Self-Service Bot’

In some embodiments, the recommendation generating device 102 may implement a chatbot (‘Self-Service Bot’). The chatbot may use Artificial Intelligence (AI)-based auto response engine that may help end users and support agents in providing relevant response by identifying the intent through conversations, and utilizing the information mined from support history and other sources to provide recommendations and predictions. As such, the chatbot may help in deskilling of support engineers, reduce load on the engineers, improve operational efficiency and throughput, improve Customer Satisfaction (CSAT) and product experience, and achieve better customer engagement with product and service.

As mentioned above, the intent identifying module 216 may identify an intent associated with the query associated with the subject data, and generate the plurality of vectors associated with the subject data, based on the query and the intent associated with the query. In particular, the intent identifying module 216 may identify the intent of user's query, and identify tagged entities in the context. Based on the identified intent, a relevant response (recommendation) may be generated. Further, an ML model (trained on enterprise data and information technology service management (ITSM) transactions may be used to generate relevant response. A messaging platform may handle internal and external communications and alerts. As such, the chatbot may be implemented for end-users and support agents (e.g. L1, L2 support agents) who require a personal assistant that can respond to repeated incidents and take predefined actions through chat or e-mail. The chatbot acts like a smart and secure tool that can help in automating testing process, and therefore saves time for upskilling. The chatbot may generate and execute tests from text data, and provide with speedy and accurate results. For example, the chatbot may be developed on top of Azure OpenAI (i.e. the GenAI model) which ensures enterprise-grade security and natural language understanding. The chatbot is user friendly and does not require any coding skills, is easy to use, scalable, secure, and can be customized to suit specific needs and preferences. Further, the chatbot may be integrated seamlessly with existing tools and platforms, such as “Microsoft Teams”, “GitHub”, “Azure DevOps”, and “Visual Studio”.

Referring now to FIG. 4, an overall architecture 400 of a self-service bot implementation 402 of the recommendation generating device 102 is illustrated, in accordance with some embodiments. The self-service bot may refer to chatbot-like interactive solution for users to ask questions about their business on a portal. The self-service bot simulate human-like conversations, enabling users to ask questions or perform actions using their own natural language. In some embodiments, the self-service bot 402 leverages GenAI model 404 (corresponding to “Azure Open AI” (GenAI model) 310) to provide a testing solution. The self-service bot may further optimize the use of GPT tokens to ensure maximum efficiency and performance. Further, as shown in FIG. 4, inputs from customers may be received that may be used by the GenAI model 404 for generating recommendations for the users during a chat with the self-service bot. Further, knowledge management database (KMDB) of the enterprise may be used by the GenAI model 404 for generating recommendations.

### ‘Co-Tester’

In some embodiments, the recommendation generating device 102 may implement another chatbot (‘Co-Tester’). The chatbot may be configured to automatically generate test scenarios, based on the requirements, user stories, or use cases. The chatbot may list sub-test scenarios and steps for each sub-test scenario, and ensure that they are comprehensive and relevant. As such, the chatbot provides for saving time and avoiding manual errors while creating test scenarios. Further, the chatbot may be configured to automatically generate test script using “GitHub Copilot”, based on the test scenarios, files, or formats. The chatbot may support different file types and formats, such as “Microsoft Word”, “Microsoft Excel”, “PDF”, etc., to generate test scripts. Furthermore, the chatbot may be configured automatically generate summaries, based on the meeting notes, documents, or other sources of information. The chatbot may be configured to summarize the main ideas, insights, and takeaways from the information, and present them in a brief and coherent format.

As such, the chatbot implementation of the recommendation generating device 102 may provide various advantages, such as automating testing process including test scenario generation, script generation, test execution, and test analysis. The chatbot further provides for reducing human intervention, errors and delays involved in the testing process, thereby saving resources. The chatbot further provides for increasing number, variety, and complexity of the test scenarios, scripts, and data, and ensuring that they are accurate, relevant, and comprehensive. The chatbot further provides for generating and executing test scenarios, scripts, queries, data, notes, and summaries, and providing with reliable and actionable results. The chatbot further provides for data protection. Furthermore, the chatbot is capable of interpreting natural language and context of the test plans, and creating test scenarios, scripts, queries, data, notes, and summaries accordingly.

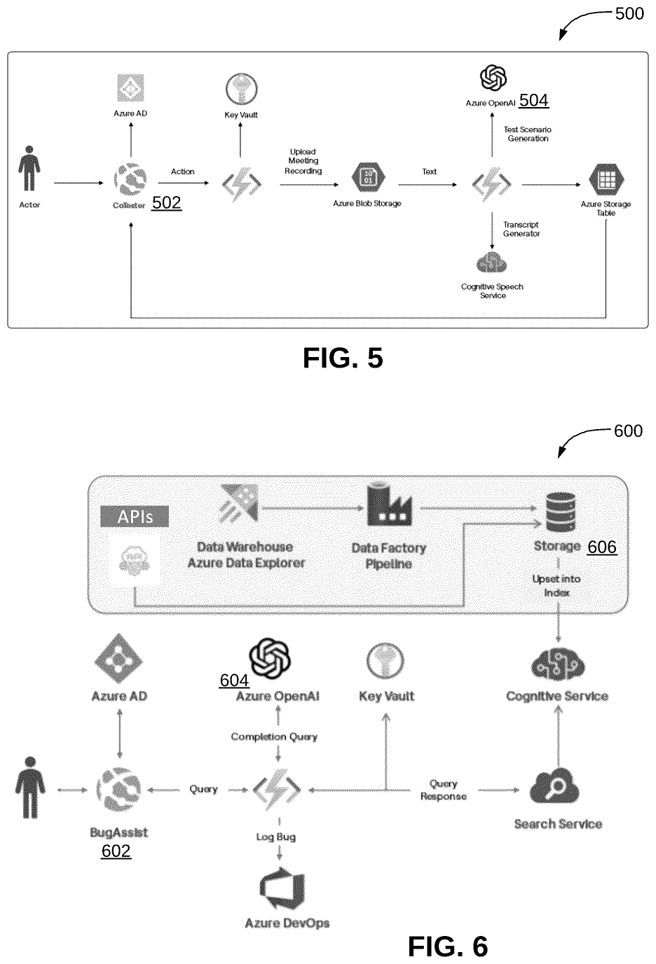

Referring now to FIG. 5, an overall architecture 500 of the chatbot implementation (‘Co-Tester’) 502 of the recommendation generating device 102 is illustrated, in accordance with some embodiments. In some embodiments, the chatbot 502 leverages “Azure” services and “Azure OpenAI” (GenAI model) 504 (corresponding to “Azure Open AI” (GenAI model) 310) to provide a testing solution. Further, “Azure” storage, “Azure Functions”, “vector DB”, and “Azure OpenAI” 504 APIs are used for handling large-scale test plans and generating high-quality tests. The chatbot may further optimize the use of GPT tokens to ensure maximum efficiency and performance.

As mentioned above, the chatbot may be an “Azure OpenAI” based solution for test automation with prompt capabilities. The chatbot enables accelerating test cycle and reducing testing efforts, as the chatbot identifies and executes test cases with high efficiency. Further, the chatbot may auto generate test scenarios, listing sub test scenarios and steps, automatically generate test scripts, generate SQL queries, generate meeting notes from meeting transcripts, summarize meeting notes, and generate realistic test data based on the input parameters. As such, the chatbot provides the advantages including reduced manual effort, costs, and time, increased test coverage and testing cycle, additional time saved for upskilling, and accurate results in less time.

The chatbot may use text data (test plans) to generate fully functional tests. Further, the chatbot is user-friendly, integrates with “Azure Devops Pipelines”, and “Jira”, provides an interactive solution, compatible with structured or unstructured test plans, etc.

### ‘BugAssist’

Another implementation (‘BugAssist’) of the recommendation generating device 102 may further provide for identifying, clustering, assigning, triaging, and logging bugs with ease and accuracy. As such, the said implementation may interact with the user through voice or text, and help with various tasks related to bug tracking and analysis. The said implementation may analyze the content of bug reports, test cases, and user feedback. The said implementation may use “Azure OpenAI” based vector representation to identify and cluster similar and duplicate bugs. The said implementation may further suggest solutions and workarounds for the existing bugs, and help avoid reporting redundant bugs. The said implementation may further triage and prioritize critical issues, based on the bug description, priority, and user impact, assign the bugs to the right team and developer, and add the appropriate tags and labels. As such, the said implementation may help to reduce the time and effort spent on bug management, and improve the software quality and reliability. Furthermore, the said implementation may automatically log bugs based on the information provided, assist in extracting relevant data from voice or text input (such as the bug title, description, repro steps, severity, etc.), and fill in the required fields in the bug tracking system. The said implementation may further generate screenshots and videos to illustrate the bug and attach them to the bug report, and thereby save time and avoid manual errors while logging bugs. The said implementation may further act as a training tool for new testers, by providing them with guidance and feedback on how to identify, report, and fix bugs, and help them learn from the best practices and experiences of other testers, and improve their skills and confidence. Further, the said implementation may help analyze the historical and current bug data, and identify the recurring patterns and trends. The said implementation may further provide intuitive and interactive dashboards to help monitor and visualize the bug metrics and performance, generate insights and recommendations on how to improve bug prevention and resolution strategies, and optimize testing and debugging process, thereby providing deeper understanding of the root causes and impacts of the bugs, and improving decision making and planning. An overall architecture of the said implementation (‘BugAssist’) of the recommendation generating device 102 is illustrated in FIG. 6.

Referring now to FIG. 6, an overall architecture 600 of an implementation (‘BugAssist’) 602 of the recommendation generating device 102 is illustrated, in accordance with some embodiments. In some embodiments, the said implementation may leverage “Azure” cloud services to provide a robust and reliable bug tracking and analysis solution. In particular, the said implementation may uses “Azure Function”, “Storage Account”, “Azure Data Factory”, “Azure Open AI” (GenAI model) 604 (corresponding to “Azure Open AI” (GenAI model) 310, 404, 504), and “Vector DB” to store, process, analyze, and present the bug data. in particular, the “Azure Function” enables the said implementation 602 to run serverless code that can scale on demand and handle complex workflows. The “Storage Account” 606 provides for storage options for the bug data. “Azure Data Factory” helps to orchestrate and automate the data movement and transformation for the bug analysis. “Azure Open AI” 604 empowers the said implementation 602 with natural language processing and generation capabilities that can understand and respond to queries and commands. “Vector DB” supports advanced analytics and ML features of the said implementation.

For example, the said implementation may use standard ML models when engaged in a conversation. Further, said implementation may be powered by “Azure OpenAI” (GenAI) with “Azure” enterprise-level security, compliance, and regional availability. As such, the said implementation may be capable of accurately detecting and analyzing defects in textual descriptions for identifying and categorizing bugs, triaging and prioritizing critical issues, leading to faster response ties and improved software quality, and identifying recurring patterns and trends enabling proactive bug prevention and early mitigation strategies.

### ‘Solution Recommender’

In some embodiments, the recommendation generating device 102 may be implemented as a ‘Solution Recommender’ so as to identify resolution to issues that are faced by users, while consuming a product or service. By way of this, the techniques performed by the recommendation generating device 102 may assist in reducing the incident volume to thereby support service teams and improve customer satisfaction. By assisting in identifying resolutions, the recommendation generating device 102 helps in achieving higher success rate for the product or service, higher Customer Satisfaction (CSAT) and lower Customer Dissatisfaction (DSAT). Further, the techniques may increase organizational focus towards innovation, optimize support operations, and provide timely resolutions to the issues.

In some embodiments, the recommendation generating device 102 may generate recommendations to resolve the issues, based on historical incident response communications, product documentation, troubleshooting guides, publicly available knowledge (from Internet), etc. In particular, large language models (LLMs) may be trained to determine the relevant resolution promptly. The recommendation generating device 102 may further use customer support data as one of its input parameters to define and decide release management. Customer support data may include feedback, issues, and requests that customers share with the software team after using their products. The input data may provide valuable insights into the quality, usability, and satisfaction of the software features, as well as the expectations and needs of the customers.

The use of customer support data may provide various advantages including: enhancing customer satisfaction (as it shows that the software team values and responds to customer feedback and delivers products that meet their needs and expectations), improving quality and usability of the software products (as it helps to identify and fix bugs, errors, and defects, and to optimize the performance and functionality of the features), and reducing cost and time of software development (as it helps to avoid rework, waste, and delays, and focus on the most important and valuable features).

In some embodiments, the customer support data may be used to: evaluate quality of feature releases, and prioritize a next set of feature releases. To evaluate the quality of feature releases, the recommendation generating device 102 uses volume and severity of tickets raised post a feature release to understand the impact and performance of the new functionality. For example, if a feature release generates a high number of tickets with critical or major issues, it indicates that the feature release has a low quality and needs urgent attention; if a feature release generates a low number of tickets with minor or trivial issues, it indicates that the feature release has a high quality and meets the customer expectations. To prioritize the next set of feature releases, the recommendation generating device 102 uses the customer support data to identify significant and urgent customer needs and expectations. For example, depending on the importance of the feature released and the customer issues reported, the recommendation generating device 102 may provide recommendations to alter future releases and prioritize fixes to the already launched feature. Alternatively, the recommendation generating device 102 may suggest new features or enhancements that are in high demand or that can solve recurring customer problems.

The sentiment identifying module 210 of the recommendation generating device 102 may collect and process data from various sources, such as social media platforms, application reviews, customer support tickets, and surveys, to measure the sentiment of the users towards a specific feature or the product as a whole. The Sentiment Identifying Module 210 may use a sentiment analysis model to classify the user feedback into positive, negative, or neutral categories, and assign a sentiment score to each feature based on the proportion and intensity of the feedback. The relevant vector selecting module 204 may identify key topics and themes (i.e. subject data) associated with the query, and extract the most relevant and actionable insights from the feedback. As such, the recommendation generating device 102 may help product managers to adopt an agile release management process based on real time user sentiment feedback, and thereby improve the quality and usability of the product by incorporating the user feedback into the feature design and development process, reducing the risk of delivering features that are not aligned with the user's needs and preferences, or that do not meet the user expectations, increasing the user engagement by showing that the product is responsive to the user feedback and that the product team cares about the user experience, enhancing the collaboration and transparency within the product team and with the stakeholders by sharing the user feedback and the sentiment analysis results and insights, and accelerating the delivery and deployment of features by focusing on the most valuable and impactful features for the users and by avoiding unnecessary or low-priority features.

The recommendation generating device 102 may leverage the GenAI model to create a smart and agile release management system that can respond to the changing needs and preferences of the customers, the market, and the competition and engineering capacity. By using various data sources to inform the product feature planning, prioritization, pricing, and adoption, the recommendation generating device 102 may deliver value to the customers and optimize the revenue and profitability of the product. The recommendation generating device 102 may use the GenAI model to enhance the customer support and feedback mechanisms, and to improve the next release plan based on the learnings from the previous cycles.

As such, the above techniques of generating recommendations may provide various advantages including increased customer satisfaction. By using the GenAI model to continuously monitor and analyze customer feedback, behavior, preferences, and needs, the techniques deliver solutions that meet or exceed customer expectations. Further, the techniques provide personalized and proactive customer support and engagement, enhancing the customer experience and retention. By using the GenAI model to automate and optimize various aspects of the release management process, such as planning, prioritization, pricing, testing, deployment, and monitoring, the techniques reduce the time and resources required to deliver high-quality products to the market. The techniques leverage the GenAI model to identify and mitigate risks, issues, and dependencies, and to implement agile and iterative methodologies, thereby improving the efficiency and effectiveness of the product development and deployment process. Furthermore, by using the GenAI model to scan and understand the market dynamics, trends, sentiments, and competition, the techniques provide for planning and executing strategic and innovative solutions that create differentiation and value for the customers and the product. The techniques use the GenAI model to dynamically adjust the product pricing and promotions based on the market demand and customer willingness to pay, maximizing the revenue and profitability of the product.

Further, the techniques leverage natural language processing, speech recognition, and vector representation to provide various advantages including efficient triaging. The techniques triage and prioritize critical issues, leading to faster response times and improved software quality. Further, the techniques analyze the content of the audio recordings and documents related to bug reports, feature requests, and user feedback, and use “Azure OpenAI” based recommender to map them as vectors and identify the most relevant vectors. The techniques transform the audio and video to text format using “Azure Cognitive Service”, and vectorize and store the converted text for future reference. As such, the techniques help in finding the root cause of the issues, and assign them to the right engineers, and track their progress and resolution.

The techniques further provide for adapting to changes in bug reporting patterns, resulting in more precise bug detection and quality improvement. The techniques provide for learning from historical data and the current context, and update recommendations accordingly. The techniques capture key market triggers, such as showstopper bugs and competition activities, and alert the users of any potential risks or opportunities. The techniques can help in adjusting feature backlog and release planning in real-time, based on the changing priorities and customer sentiment. The techniques further provide for historical trend analysis of feature sets and adoption, and clustering and optimizing the feature data sets based on the internal (engineering capacity, quality, and release plans) and external inputs (competition and sentiment analysis). Accordingly, the techniques generate insights and reports based on how the product features are performing in the market, how they are impacting customer satisfaction and retention, and how they are contributing to revenue and growth. The techniques help in identifying the most valuable and impactful features, and allocate resources and efforts accordingly. The techniques further provide for enhancing the accessibility and usability of your software, reaching a wider and more diverse audience, and improving the experience and engagement with the software. In a nutshell, the techniques help in streamlining the software development process, and increasing productivity and efficiency.

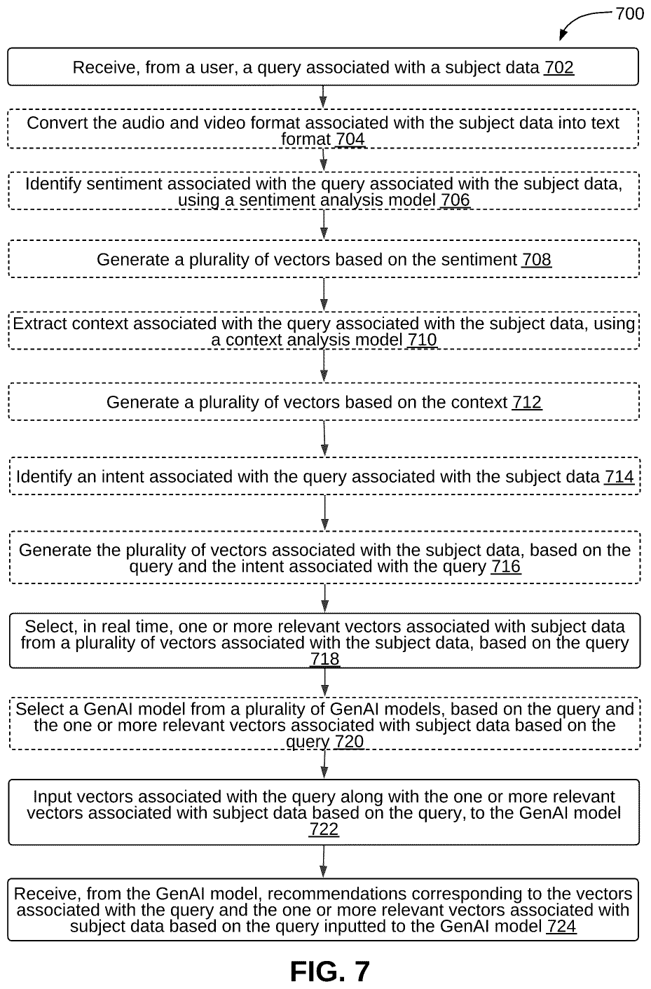

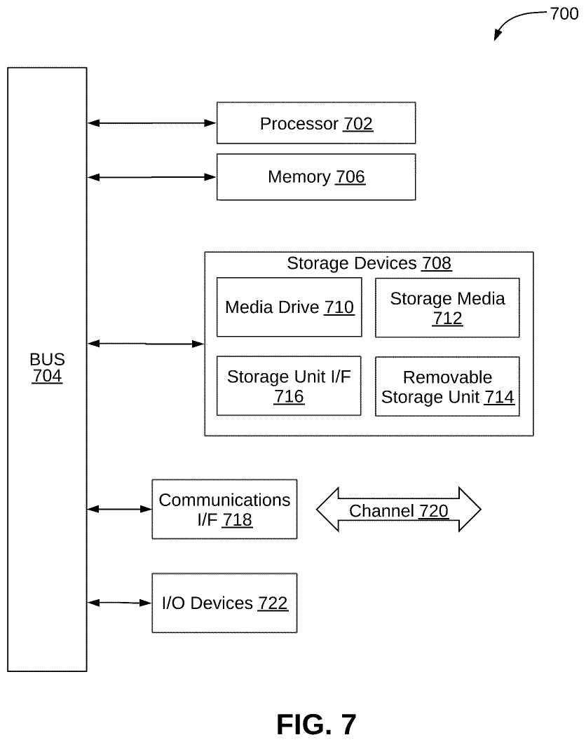

Referring now to FIG. 7, a flowchart of a method 700 of generating recommendations is illustrated, in accordance with some embodiments. in some embodiments, the method 700 may performed by the recommendation generating device 102.

At step 702, a query associated with a subject data may be received from a user. The subject data may include internal data and external data associated with the query. The internal data may include: engineering data, connectors data, and plugins data associated with the subject data. The external data may include customer feedback data, competitor analysis data, and pricing data associated with the subject data. The subject data may further include historical data corresponding to failure incidents and troubleshooting incidents. The subject data may be associated with one of: a text format, image format, an audio format, and a video format.

At step 704, the audio and the video format associated with the subject data may be converted into text format. Further, a plurality of vectors associated with the subject data may be generated based on the text format associated with the subject data. For example, the text format may be JSON format.

At step 706, a sentiment associated with the query associated with the subject data may be identified, using a sentiment analysis model. At step 708, the plurality of vectors may be generated based on the sentiment. At step 710, a context associated with the query associated with the subject data may be extracted, using a context analysis model. At step 712, the plurality of vectors may be generated based on the context. At step 714, an intent associated with the query associated with the subject data may be identified. At step 716, a plurality of vectors associated with the subject data may be generated, based on the query and the intent associated with the query.

At step 718, one or more relevant vectors associated with subject data may be selected in real-time from the plurality of vectors associated with the subject data, based on the query. The plurality of vectors associated with the subject data may be already stored in the database 104.

At step 720, a Generative Artificial Intelligence (GenAI) model may be selected from a plurality of GenAI models, based on the query and the one or more relevant vectors associated with subject data based on the query. At step 722, vectors associated with the query along with the one or more relevant vectors associated with subject data based on the query may be inputted, to the Generative Artificial Intelligence (GenAI) model. At step 724, recommendations corresponding to the vectors associated with the query and the one or more relevant vectors associated with subject data may be received from the GenAI model, based on the query inputted to the GenAI model.

Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication media. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during the execution of instructions to be executed by processor 802. The computing system 800 may likewise include a read-only memory (“ROM”) or other static storage device coupled to bus 804 for storing static information and instructions for the processor 802.

The computing system 800 may also include storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 812 may include, for example, a hard disk, magnetic tape, flash drive, or other fixed or removable media that is read by and written to by the media drive 810. As these examples illustrate, the storage media 812 may include a computer-readable storage medium having stored therein particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro-USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

One or more techniques for generating recommendations for enhancement of an existing legacy or monolith application are disclosed. The techniques provide for a solution for visualizing different data-types, irrespective of each data-type having their respective representation. As such, the techniques allow developers to visualize geometric entities while debugging to thereby aid in code understanding and maintenance. Further, the techniques are not limited by the IDE extendibility or the programming language. Furthermore, the above techniques provide a two-way communication channel that allows the debugger to post queries and receive corresponding rendering. The techniques are independent of different IDEs and platforms. The techniques help in reducing overall application (code) development time and effort.

It is intended that the disclosure and examples be considered as exemplary only, with a true scope and spirit of disclosed embodiments being indicated by the following claims.

What is claimed is:

1. A method of generating recommendations, the method comprising:
receiving, by a recommendation generating device, from a user, a query associated with a subject data;
selecting, by the recommendation generating device, in real time, one or more relevant vectors associated with subject data from a plurality of vectors associated with the subject data, based on the query, wherein the plurality of vectors associated with the subject data are stored in a database;
inputting, by the recommendation generating device, vectors associated with the query along with the one or more relevant vectors associated with subject data based on the query, to a Generative Artificial Intelligence (GenAI) model; and
receiving, by the recommendation generating device, from the GenAI model, recommendations corresponding to the vectors associated with the query and the one or more relevant vectors associated with subject data based on the query inputted to the GenAI model.

2. The method of claim 1,
wherein the subject data comprises internal data and external data associated with the query,
wherein the internal data comprises: engineering data, connectors data, and plugins data associated with the subject data, and
wherein the external data comprises: customer feedback data, competitor analysis data, and pricing data associated with the subject data.

3. The method of claim 1, wherein the method further comprises:
identifying sentiment associated with the query associated with the subject data, using a sentiment analysis model; and
generating the plurality of vectors associated with the subject data, based on the sentiment.

4. The method of claim 1 further comprising:
extracting context associated with the query associated with the subject data, using a context analysis model; and
generating the plurality of vectors associated with the subject data, based on the context.

5. The method of claim 1, wherein the subject data is associated with one of: a text format, an audio format, and a video format.

6. The method of claim 5, further comprising:
converting the audio format and the video format associated with the subject data into text format,
wherein the plurality of vectors associated with the subject data are generated based on the text format associated with the subject data, and
wherein the text format is a JSON format.

7. The method of claim 1, further comprising:
identifying an intent associated with the query associated with the subject data; and
generating the plurality of vectors associated with the subject data, based on the query and the intent associated with the query.

8. The method of claim 1, wherein the subject data further comprises historical data corresponding to failure incidents and troubleshooting incidents.

9. The method of claim 1 further comprising:
selecting the GenAI model from a plurality of GenAI models, based on the query and the one or more relevant vectors associated with subject data based on the query.

10. A system for generating recommendations, the system comprising:
a processor; and
a memory communicatively coupled to the processor, wherein the memory stores a plurality of instructions, which upon execution by the processor, cause the processor to:
receive, from a user, a query associated with a subject data;
select, in real time, one or more relevant vectors associated with subject data from a plurality of vectors associated with the subject data, based on the query, wherein the plurality of vectors associated with the subject data are stored in a database;
input, vectors associated with the query along with the one or more relevant vectors associated with subject data based on the query, to a Generative Artificial Intelligence (GenAI) model; and
receive, from the GenAI model, recommendations corresponding to the vectors associated with the query and the one or more relevant vectors associated with subject data based on the query inputted to the GenAI model.

11. The system of claim 10, wherein the plurality of instructions upon execution by the processor further cause the processor to:
identify sentiment associated with the query associated with the subject data, using a sentiment analysis model;
extract context associated with the query associated with the subject data, using a context analysis model;
identify an intent associated with the query associated with the subject data; and
generate the plurality of vectors associated with the subject data, based on the query, the intent associated with the query, the context associated with the query, and the intent associated with the query.

12. The system of claim 10, wherein the subject data is associated with one of: a text format, an audio format, and a video format, and wherein the plurality of instructions upon execution by the processor further cause the processor to:
convert the audio format and the video format associated with the subject data into text format,
wherein the plurality of vectors associated with the subject data are generated based on the text format associated with the subject data, and
wherein the text format is a JSON format.

13. The system of claim 10, wherein the plurality of instructions upon execution by the processor further cause the processor to:
identify an intent associated with the query associated with the subject data; and
generate the plurality of vectors associated with the subject data, based on the query and the intent associated with the query.

14. The system of claim 10, wherein the plurality of instructions upon execution by the processor further cause the processor to:
select the GenAI model from a plurality of GenAI models, based on the query and the one or more relevant vectors associated with subject data based on the query.

15. A non-transitory computer-readable medium storing computer-executable instructions for generating recommendations, the computer-executable instructions configured for:
receiving, from a user, a query associated with a subject data;
selecting, in real time, one or more relevant vectors associated with subject data from a plurality of vectors associated with the subject data, based on the query, wherein the plurality of vectors associated with the subject data are stored in a database;
inputting vectors associated with the query along with the one or more relevant vectors associated with subject data based on the query, to a Generative Artificial Intelligence (GenAI) model; and
receiving, from the GenAI model, recommendations corresponding to the vectors associated with the query and the one or more relevant vectors associated with subject data based on the query inputted to the GenAI model.

16. The non-transitory computer-readable medium of claim 15, wherein the computer-executable instructions are further configured for:
identifying sentiment associated with the query associated with the subject data, using a sentiment analysis model; and
generating the plurality of vectors associated with the subject data, based on the sentiment.

17. The non-transitory computer-readable medium of claim 15, wherein the computer-executable instructions are further configured for:
extracting context associated with the query associated with the subject data, using a context analysis model; and
generating the plurality of vectors associated with the subject data, based on the context.

18. The non-transitory computer-readable medium of claim 15, wherein the subject data is associated with one of: a text format, an audio format, and a video format, and wherein the computer-executable instructions are further configured for:
converting the audio format and the video format associated with the subject data into text format,
wherein the plurality of vectors associated with the subject data are generated based on the text format associated with the subject data, and
wherein the text format is a JSON format.

19. The non-transitory computer-readable medium of claim 15, wherein the computer-executable instructions are further configured for:
identifying an intent associated with the query associated with the subject data; and
generating the plurality of vectors associated with the subject data, based on the query and the intent associated with the query.

20. The non-transitory computer-readable medium of claim 15, wherein the computer-executable instructions are further configured for:
selecting the GenAI model from a plurality of GenAI models, based on the query and the one or more relevant vectors associated with subject data based on the query.
